(19) United States
(12) Patent Application Publication
(10) Pub. No.: US 2018/0072094 A1
(43) Pub. Date: Mar. 15, 2018

(54) WHEEL COVER OF ALUMINUM ALLOY WHEEL

(71) Applicant: SOUN MIIN CO., LTD., Tainan City (TW)

(72) Inventor: FU-YUAN HSIEH, TAINAN CITY (TW)

(21) Appl. No.: 15/262,397

(22) Filed: Sep. 12, 2016

(51) Int. Cl. B60B 7/06; B60B 7/00; B60B 7/12

(52) U.S. Cl. CPC B60B 7/068; B60B 2360/104; B60B 7/12; B60B 7/0013

(57) ABSTRACT

A wheel cover of an aluminum alloy wheel is revealed. The wheel cover is located on and covered an outer side of the aluminum alloy wheel. A peripheral wall is axially extended from a circumference of a central insertion hole of the wheel cover. The peripheral wall is fitted into a central insertion hole of the aluminum alloy wheel. A locking part on each spring arranged around the peripheral wall is locked with an inner edge of the insertion hole of the aluminum alloy wheel. The production of the aluminum alloy wheel is generally based on the central insertion hole thereof. The wheel cover and the insertion hole are connected mainly at the central insertion hole owing to precision of the size and position of the central insertion hole. Thereby the wheel cover and the aluminum alloy wheel are assembled conveniently.

### BACKGROUND OF THE INVENTION

### Field of the Invention

The present invention relates to a wheel cover of an aluminum alloy wheel, especially to a wheel cover that is able to be assembled with an aluminum alloy wheel precisely.

### Descriptions of Related Art

The wheel cover of an aluminum alloy wheel available now generally is disposed with a plurality of ribs and holes similar to those of the aluminum alloy. A mounting flange is projecting from an edge of a circumference of the hole so that the wheel cover is mated and locked with the aluminum alloy wheel. However, the aluminum alloy wheel from the same company in car manufacturing may have difference in the tolerance of shape and position owing to different outsourcing contractors. Thus the mounting flange on the hole of the wheel cover is unable to be mounted into the hole of the aluminum alloy wheel or unable to be mounted into the hole of the aluminum alloy wheel firmly and precisely. The problem that the wheel cover is unable to be applied to the aluminum alloy wheels made from different manufacturers causes troubles in the development and design of the wheel cover.

### SUMMARY OF THE INVENTION

Therefore it is a primary object of the present invention to provide a wheel cover of an aluminum alloy wheel that is produced based on fastener holes thereof being passed through by bolts and a central insertion hole of the aluminum alloy wheel for precise assembly of the wheel cover with the aluminum alloy wheel.

In order to achieve the above object, a wheel cover of an aluminum alloy according to the present invention is having a shape similar to the aluminum alloy wheel and mated with the aluminum alloy wheel. The wheel cover is set on and connected to an outer side of the aluminum alloy wheel. A plurality of through holes is disposed on the wheel cover and corresponding to a plurality of holes of the aluminum alloy wheel. An edge wall is extended from a circumference of the through hole and the edge wall of the through hole is fitted in the hole of the aluminum alloy wheel correspondingly. An insertion hole is arranged at a center of the wheel cover and a peripheral wall is axially extended from a circumference of the insertion hole and located on an inner surface of the wheel cover. The peripheral wall of the insertion hole is mounted into a central insertion hole of the aluminum alloy wheel. A plurality of springs is disposed around an inner surface of the peripheral wall of the insertion hole while a locking part is formed on the spring and is locked with and positioned by an inner edge of the central insertion hole of the aluminum alloy wheel.

A plurality of teeth is formed on the edge wall of the through hole of the wheel cover and is engaged on an inner edge of the hole of the aluminum alloy wheel.

A plurality of fastener holes is arranged around the insertion hole of the wheel cover and a circumference wall is axially extended from the inner surface of the wheel cover and located around the fastener hole; the circumference wall of the fastener hole is mounted into a locking hole of the aluminum alloy wheel correspondingly.

A plurality of gaps is formed on the circumference wall of the fastener hole of the wheel cover.

The springs of the insertion hole of the wheel cover are integrally connected to the inner surface of the peripheral wall of the insertion hole.

An inner surface of the spring of the wheel cover is disposed with a positioning portion having a mounting grove arranged therein. The wheel cover further includes a reinforcement that is mounted in the insertion hole of the wheel cover and arranged with a plurality of ribs each of which is corresponding to the spring and mounted in a mounting groove of the positioning portion of the spring.

A plurality of assembly portions is formed on an inner edge of the peripheral wall of the insertion hole of the wheel cover. A slot is axially passed through the assembly portion and the spring is mounted in the slot of the assembly portion. One end of the spring mounted into the slot is disposed with a hook part for being hooked on and positioned by an inner wall of the slot of the assembly portion while the other end of the spring is extended from the slot and is arranged with a locking part.

A plurality of locking slots is set on an inner edge of the central insertion hole of the aluminum alloy wheel. The locking parts on the springs of the wheel cover are locked with and positioned by the locking slots correspondingly.

The wheel cover further includes a wheel cap that covers on an outer side of the insertion hole of the wheel cover. A plurality of flat springs is disposed on an inner edge of the wheel cap and a projecting part is arranged at the flat spring. A plurality of locking grooves is set on the peripheral wall of the insertion hole of the wheel cover. The projecting parts of the flat springs of the wheel cap are locked with and positioned by the locking grooves of the peripheral wall of the insertion hole of the wheel cover.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a longitudinal sectional view of an embodiment according to the present invention;

FIG. 3 is another longitudinal sectional view of an embodiment according to the present invention;

FIG. 4 is an explosive view of another embodiment according to the present invention;

FIG. 5 is a longitudinal sectional view of another embodiment according to the present invention;

FIG. 6 is an explosive view of a further embodiment according to the present invention.

### DETAILED DESCRIPTION OF THE PREFERRED EMBODIMENT

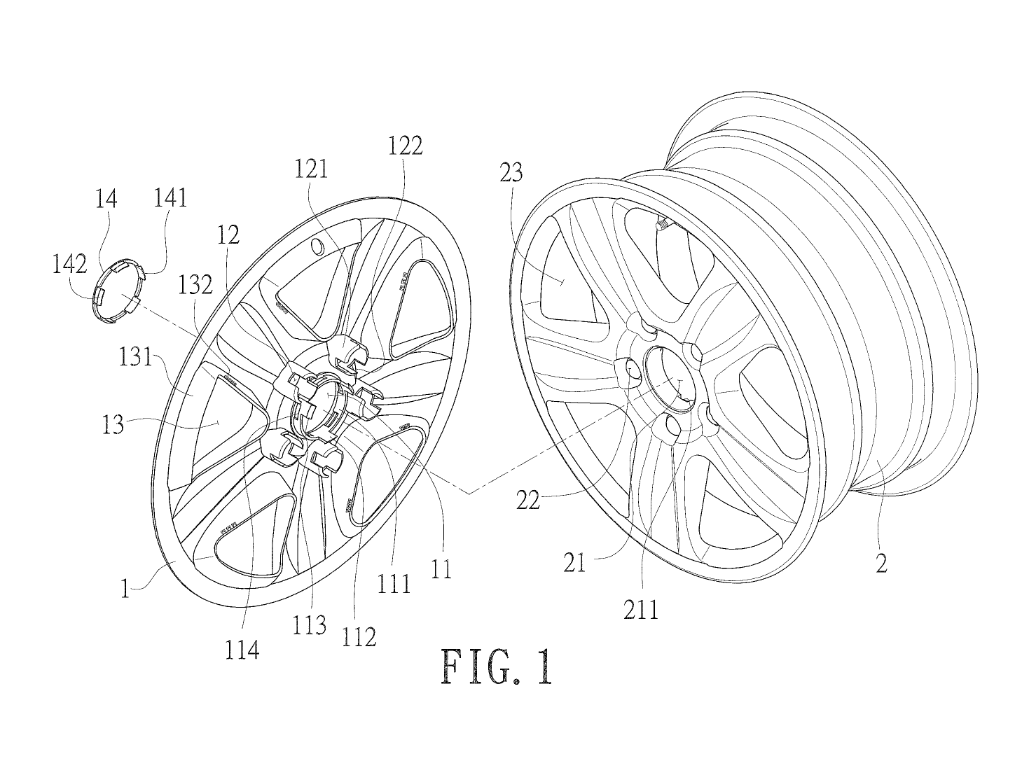

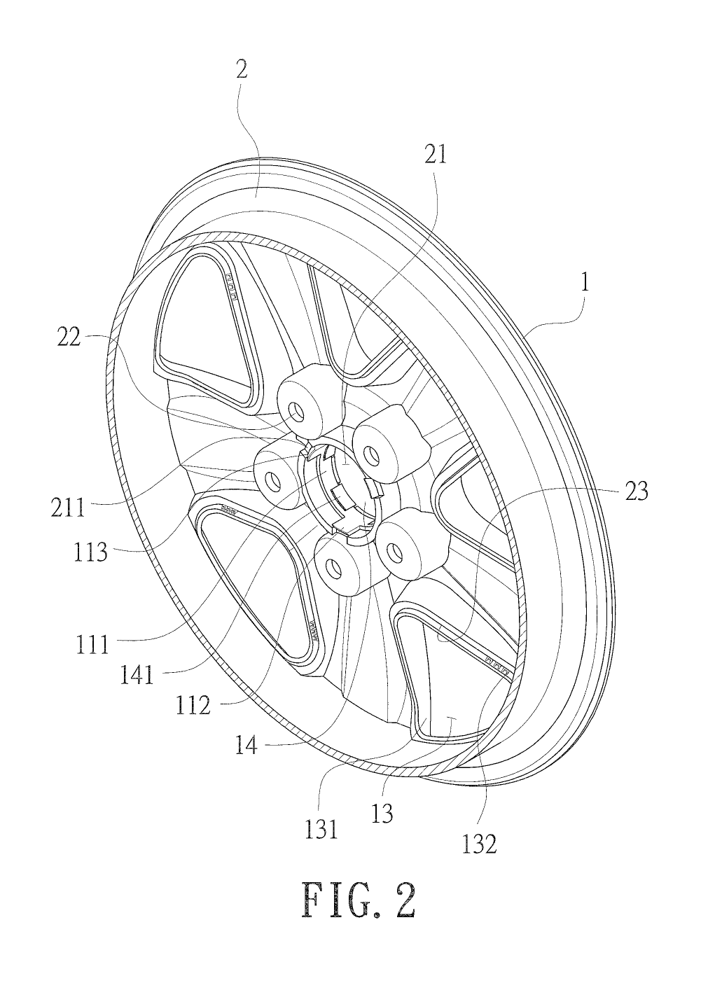

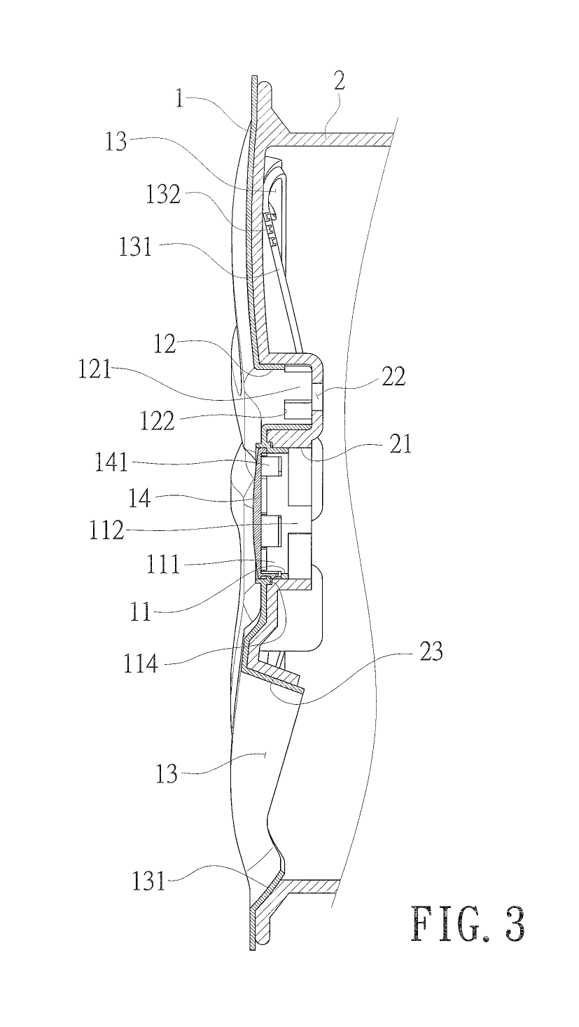

Refer to FIG. 1, FIG. 2 and FIG. 3, a wheel cover 1 of an aluminum alloy wheel of the present invention is having a shape similar to the aluminum alloy wheel 2 and mated with the aluminum alloy wheel 2. The wheel cover 1 is set on and connected to an outer side of the aluminum alloy wheel 2. The wheel cover 1 consists of an insertion hole 11, a plurality of fastener holes 12, a plurality of through holes 13 and a wheel cap 14. The insertion hole 11 is at the center of the wheel cover 1 and a peripheral wall 111 is axially extended from a circumference of the insertion hole 11 and located on an inner surface of the wheel cover 1. The peripheral wall 111 is fitted into a central insertion hole 21 of the aluminum alloy wheel 2. A plurality of springs 112 is integrally connected to and arranged around an inner surface of the peripheral wall 111 and a locking part 113 is formed on each spring 112. A plurality of locking slots 211 is formed on an inner edge of the central insertion hole 21 of the aluminum alloy wheel 2. The locking part 113 is locked with and positioned by the corresponding locking slot 211. The fastener holes 12 are arranged around the insertion hole 11 of the wheel cover 1 and a circumference wall 121 is axially extended from the inner surface of the wheel cover 1 and located around the fastener hole 12. The circumference wall 121 is mounted into a corresponding locking hole 22 of the aluminum alloy wheel 2. A plurality of gaps 122 is formed on the circumference wall 121 of the fastener hole 12 of the wheel cover 1. An edge wall 131 is axially extended from the inner surface of the wheel cover 1 and along a circumference of each through hole 13. The edge wall 131 of the through hole 13 is received in a corresponding hole 23 of the aluminum alloy wheel 2. A plurality of teeth 132 is formed on the edge wall 131 of the through hole 13 of the wheel cover 1 and used for engagement on an inner edge of the hole 23 of the aluminum alloy wheel 2. As to the wheel cap 14, it's used to cover on an outer side of the central insertion hole 11 of the wheel cover 1. A plurality of flat springs 141 is disposed on an inner edge of the wheel cap 14 and a projecting part 142 is arranged at each flat spring 141. A plurality of locking grooves 114 is set on the peripheral wall 111 of the insertion hole 11 of the wheel cover 1. The projecting parts 142 of the flat springs 141 are corresponding to the locking grooves 114 of the peripheral wall 111 so as to lock with each other.

While in use, the wheel cover 1 of the present invention is covered on an outer side of the aluminum alloy wheel 2, the peripheral wall 111 of the insertion hole 11 of the wheel cover 1 is mounted into the central insertion hole 21 of the aluminum alloy wheel 2. The locking parts 113 on the springs 112 around the inner surface of the peripheral wall 111 are locked in and positioned by the locking slots 211 on the inner edge of the central insertion holes 21 of the aluminum alloy wheel 2 correspondingly. The circumference wall 121 of each fastener hole 12 of the wheel cover 1 is fitted into the corresponding locking hole 22 of the aluminum alloy wheel 2 while the peripheral wall 111 of the insertion hole 11 of the wheel cover 1 being mounted into the central insertion hole 21 of the aluminum alloy wheel 2. The circumference wall 121 of the fastener hole 12 is elastic owing to the gaps 122 on the circumference wall 121 of the fastener hole 12. Thus the circumference wall 121 of the fastener hole 12 fitted into the corresponding locking hole 22 of the aluminum alloy wheel 2 is able to be leaning against and positioned by a wall of the locking hole 22 of the aluminum alloy wheel 2. Moreover, the edge wall 131 of each through hole 13 of the wheel cover 1 is mounted into the corresponding hole 23 of the aluminum alloy wheel 2 and the teeth 132 on the edge wall 131 of the through hole 13 is engaged with the inner edge of the hole 23 of the aluminum alloy wheel 2 simultaneously. Lastly the wheel cap 14 is covered on an outer side of the insertion hole 11 of the wheel cover 1. The projecting parts 142 on the flat spring 141 of the wheel cap 14 are locked with and positioned by the locking grooves 114 set on the peripheral wall 111 of the insertion hole 11 of the wheel cover 1 so as to cover the wheel cap 14 on the insertion hole 11 of the wheel cover 1 firmly.

The production of the aluminum alloy wheel 2 is generally based on the central insertion hole 21 thereof. The central insertion hole 21 of the aluminum alloy wheel 2 is used as a main connection area of the aluminum alloy wheel 2 with the wheel cover 1 owing to the minimum tolerance feature of the central insertion hole 21. Moreover, the locking holes 22 of the aluminum alloy wheel 2 allow fasteners such as bolts to pass through for connecting the aluminum alloy wheel 2 to a car knuckle hub. Thus the locking holes 22 of the aluminum alloy wheel 2 should meet the requirements for precision of the size and the position. Thus the locking holes 22 of the aluminum alloy wheel 2 can be used as another main connection area of the aluminum alloy wheel 2 with the wheel cover 1.

The aluminum alloy wheel 2 from the same company in car manufacturing may have difference in the tolerance of shape and position owing to different outsourcing contractors. The size of the edge wall 131 of each through hole 13 of the wheel cover 1 can be designed into a smaller one for being fitted to all kinds of the aluminum alloy wheel 2 available on the market now. Besides the teeth 132 being engaged on the inner edge of the hole 23 of the aluminum alloy wheel 2, the features of the locking pats 113 of the springs 112 corresponding to, locked with and positioned by the central insertion hole 21 of the aluminum alloy wheel 2, and the elastic circumference wall 121 of the fastener hole 12 against and positioned by the corresponding locking hole 22 of the aluminum alloy wheel 2 make the wheel cover 1 not only become more convenient in assembly with the aluminum alloy wheel 2, but also become easier in manufacturing.

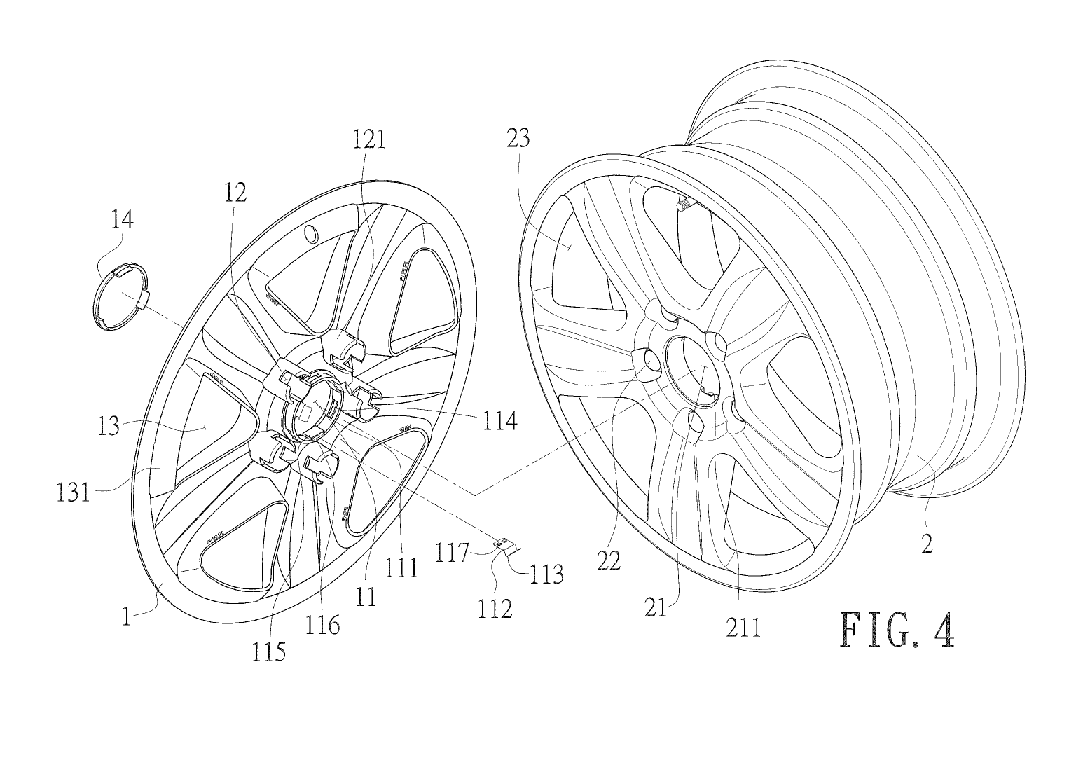

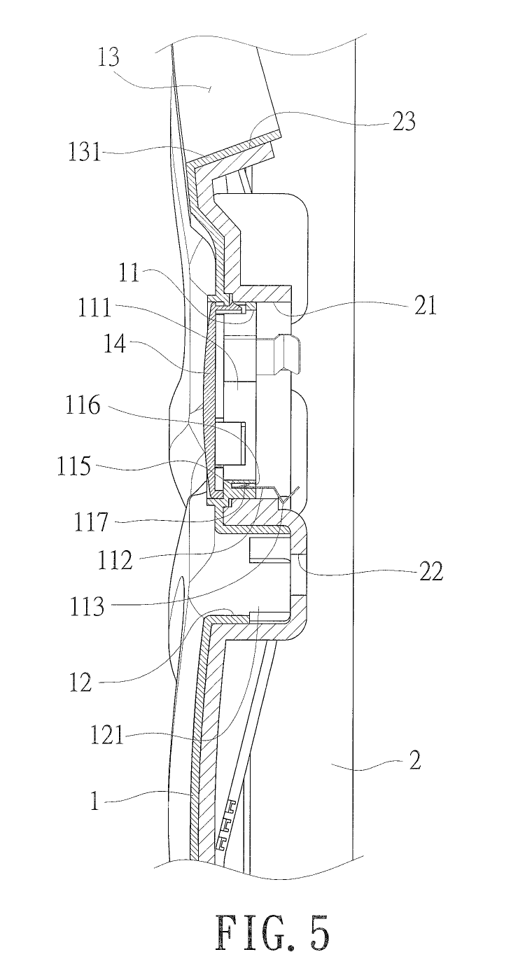

Refer to FIG. 4 and FIG. 5, another embodiment is revealed. A plurality of assembly portions 115 is formed on an inner edge of the peripheral wall 111 of the insertion hole 11 of the wheel cover 1. A slot 116 is axially passed through the assembly portion 115 and a spring 112 is mounted in the slot 116 of the assembly portion 115. One end of the spring 112 mounted into the slot 116 is disposed with a hook part 117 while the other end of the spring 112 extended from the slot 116 is arranged with a locking part 113. The hook part 117 is hooked on and positioned by an inner wall of the slot 116 while the locking part 113 is locked with and positioned by the corresponding locking slot 211 on the inner edge of the central insertion hole 21 of the aluminum alloy wheel 2. Thereby the wheel cover 1 of the present invention can be locked in and positioned by the inner edge of the central insertion hole 21 of the aluminum alloy wheel 2.

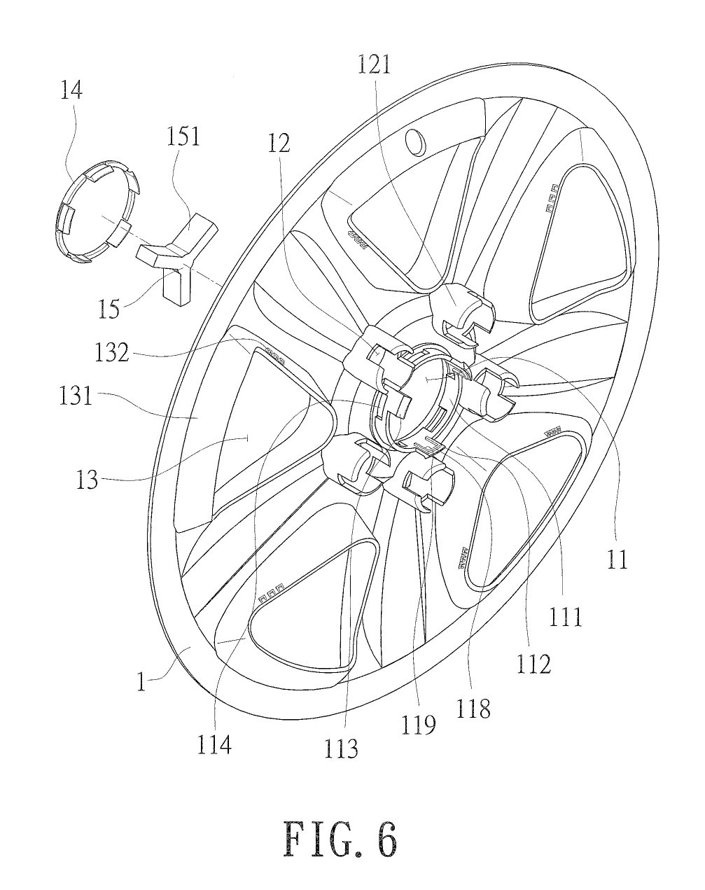

Refer to FIG. 6, a further embodiment is disclosed. An inner surface of the spring 112 of the wheel cover 1 is disposed with a projecting U-shaped positioning portion 118 having a mounting groove 119 therein. An opening of the mounting groove 119 is toward an outer side of the insertion hole 11. The wheel cover 1 further includes a reinforcement 15 that is arranged with a plurality of ribs 151 and is mounted in the insertion hole 11 of the wheel cover 1. Each of the ribs 151 is corresponding to the spring 112 and mounted in the mounting groove 119 of the positioning portion 118 on the inner surface of each spring 112. Thereby the reinforcement 15 against each spring 112 enhances the strength of the springs 112.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A wheel cover of an aluminum alloy wheel being covered on an outer side of the aluminum alloy wheel comprising:
a plurality of through holes corresponding to a plurality holes of the aluminum alloy wheel and the through hole having an edge wall extended from a circumference thereof and the edge wall of the through hole being received in the hole of the aluminum alloy wheel correspondingly; and
an insertion hole at a center thereof with a peripheral wall axially extended from a circumference thereof and located on an inner surface of the wheel cover; the peripheral wall of the insertion hole being fitted into a central insertion hole of the aluminum alloy wheel;
wherein a plurality of springs is disposed around an inner surface of the peripheral wall of the insertion hole while a locking part is formed on the spring and is locked with and positioned by an inner edge of the central insertion hole of the aluminum alloy wheel.

2. The device as claimed in claim 1, wherein a plurality of teeth is formed on the edge wall of the through hole of the wheel cover and is engaged on an inner edge of the hole of the aluminum alloy wheel.

3. The device as claimed in claim 2, wherein a plurality of fastener holes is arranged around the insertion hole of the wheel cover and a circumference wall is axially extended from the inner surface of the wheel cover and located around the fastener hole; the circumference wall of the fastener hole is mounted into a locking hole of the aluminum alloy wheel correspondingly.

4. The device as claimed in claim 3, wherein a plurality of gaps is formed on the circumference wall of the fastener hole of the wheel cover.

5. The device as claimed in claim 1, wherein a plurality of fastener holes is arranged around the insertion hole of the wheel cover and a circumference wall is axially extended from the inner surface of the wheel cover and located around the fastener hole; the circumference wall of the fastener hole is mounted into a locking hole of the aluminum alloy wheel correspondingly.

6. The device as claimed in claim 5, wherein a plurality of gaps is formed on the circumference wall of the fastener hole of the wheel cover.

7. The device as claimed in claim 1, wherein the springs of the insertion hole of the wheel cover are integrally connected to the inner surface of the peripheral wall of the insertion hole.

8. The device as claimed in claim 7, wherein an inner surface of the spring of the wheel cover is disposed with a positioning portion having a mounting groove arranged therein; the wheel cover further includes a reinforcement that is mounted in the insertion hole of the wheel cover and arranged with a plurality of ribs each of which is corresponding to the spring and mounted in the mounting groove of the positioning portion of the spring.

9. The device as claimed in claim 1, wherein a plurality of assembly portions is formed on an inner edge of the peripheral wall of the insertion hole of the wheel cover; a slot is axially passed through the assembly portion and the spring is mounted in the slot of the assembly portion; one end of the spring mounted into the slot is disposed with a hook part for being hooked on and positioned by an inner wall of the slot of the assembly portion while the other end of the spring is extended from the slot and is arranged with a locking part.

10. The device as claimed in claim 1, wherein a plurality of locking slots is set on an inner edge of the central insertion hole of the aluminum alloy wheel; the locking parts on the springs of the wheel cover are locked with and positioned by the locking slots correspondingly.

11. The device as claimed in claim 1, wherein an inner surface of the spring of the wheel cover is disposed with a positioning portion having a mounting groove arranged therein; the wheel cover further includes a reinforcement that is mounted in the insertion hole of the wheel cover and arranged with a plurality of ribs each of which is corresponding to the spring and mounted in the mounting groove of the positioning portion of the spring.

12. The device as claimed in claim 1, wherein the wheel cover further includes a wheel cap that covers on an outer side of the insertion hole of the wheel cover; a plurality of flat springs is disposed on an inner edge of the wheel cap and a projecting part is arranged at the flat spring; a plurality of locking grooves is set on the peripheral wall of the insertion hole of the wheel cover; the projecting parts of the flat springs of the wheel cap are locked with and positioned by the locking grooves of the peripheral wall of the insertion hole of the wheel cover.
